(19) United States
(12) Patent Application Publication
(10) Pub. No.: US 2003/0225575 A1
(43) Pub. Date: Dec. 4, 2003

(54) Method and apparatus for a differentiated voice output

(75) Inventors: Georg Obert, Muenchen (DE); Klaus-Josef Bengler, Regenstauf (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke Aktiengesellschaft

(21) Appl. No.: 10/465,839

(22) Filed: Jun. 20, 2003

Related U.S. Application Data
(63) Continuation of application No. PCT/EP01/13488, filed on Nov. 21, 2001.

(30) Foreign Application Priority Data
Dec. 20, 2000 (DE) 100 63 503.2

(51) Int. Cl. G10L 19/12

(52) U.S. Cl. 704/221

(57) ABSTRACT

In a method and apparatus for a differentiated voice output, systems existing in a vehicle, such as the on-board computer, the navigation system, and others, can be connected with a voice output device. The voice outputs of different systems can be differentiated by way of voice characteristics.

### CROSS-REFERENCE TO RELATED APPLICATIONS

This application is a continuation of PCT Application No. PCT/EP01/13488 filed on Nov. 21, 2001 corresponding to German priority application 100 63 503.2, filed Dec. 20, 2000, the disclosure of which is expressly incorporated by reference herein.

### BACKGROUND AND SUMMARY OF THE INVENTION

The present invention relates to a method and apparatus for a differentiated voice output or voice production as well as a system which incorporates the same, and to combinations of a voice output device with at least two systems, particularly for a use in a vehicle.

Individual vehicle systems frequently have an acoustic man-machine interface for the voice output. In such systems, a voice output module is assigned directly, usually using voice-producing methods based on pulse-code modulation (=PCM), in which a subsequent compression (for example, MPEG) may be connected. Other systems use voice synthesis methods which form words and sentences (signal manipulation) mainly by way of the compilation of syllable segments (phonemes).

The above-mentioned voice output methods are speaker dependent, requiring that the same human speaker always be used for recordings when the word or text range is to be expanded. Furthermore, like a high-quality phoneme synthesis by signal manipulation, PCM methods require considerable storage space for filing texts or syllable segments. In both methods, the storage space requirement is considerably increased when different national languages are to be outputted.

Furthermore, methods are known which are based on a complete synthesis of the language, particularly by converting the human vocal tract as an electrical equivalence, and using a sound generator and several filters on the output side (source—filter model). One device operating according to this method is a so-called characteristic-frequency synthesizer (for example, KLATTALK). Such a characteristic-frequency synthesizer has the advantage that voice-characteristic features can be influenced.

One object of the present invention is to provide a method and apparatus which can achieve a differentiated voice output.

Another object of the invention is to provide a system that uses the voice output method and apparatus.

Still another object of the invention is to provide a combination of a voice output device with at least two systems, particularly for a use in vehicles.

These and other objects and advantages are achieved by the method and apparatus according to the invention, which has the advantage that a single voice output device or voice synthesis device can achieve voice outputs for different systems, with each system being identifiable by voice-characteristic differences.

According to a preferred embodiment of the invention, a parameter block is assigned to each system and is used by the voice synthesis device during a voice output from this system. For example, a first parameter block is provided for an on-board computer; a second parameter block is provided for a navigation system; a third parameter block is provided for traffic information; or a fourth parameter block is provided for a TTS system (Text-to-Speech System), such as email. Furthermore, one or more additional parameter blocks are provided for additional systems.

The voice synthesis device produces the voice output as a function of the assigned parameter block, for example, with a soft female voice for a navigation system, or with a hard male bass for the voice output of traffic reports.

According to a preferred embodiment of the invention, a method and an apparatus are used for a full synthesis of the voice, preferably a characteristic-frequency synthesizer. The control parameters for the synthesizer are divided into classes. One class of dynamic parameters controls the articulation, like the movement of the voice tract during the speaking. A second class of static parameters controls speaker-characteristic features, such as the fundamental frequency of the generator and fixed characteristic frequencies which are formed in the case of a child, a woman or a male speaker as a result of the different geometrical dimension of the voice tract.

An expanded model of the characteristic-frequency synthesizer can achieve a separate generation of voiced and unvoiced sounds. As a result of further parameters, additional resonators or attenuators can be connected or the dynamic parameters for the articulation can be influenced.

The method and apparatus according to the invention are especially suitable for use in systems of a vehicle. For a voice output, each system has two possibilities for controlling the voice output. The first comprises sending an output of control commands for the voice articulation, the sequence of the control parameters for words, sentences and sentence sequences being stored in the system. In the second, a second output switches a parameter block which determines the speaker characteristic.

As an alternative, or in addition, it is also possible to store this parameter data block directly in the system and, in the case of a required voice output, load the parameter data block into the voice synthesis device.

According to a further preferred embodiment, which can be used as an alternative or in addition to the above-mentioned embodiments, for the differentiation of the information sources (that is, of the systems which carry out a voice output), the generator and characteristic-frequency parameters can also be dynamically changed. As a result, audible differences in the prosody can be obtained, such as the duration and/or emphasis of syllable segments and/or the melody of the sentence. Specifically, a prosodic modulation can be utilized as a function of, for example, a traffic condition or a traffic situation for the voice output of announcement texts. Finally, the significance of an information can be expressed by modulating the voice.

The invention has the advantage that, for example, in a vehicle, only a single voice generator with a small parameter memory can be controlled by several information sources. In this case, the information sources can be equipped with different voice characteristics.

When a full synthesis device is used, such as a vocal-tract synthesis device, the method is speaker-independent and high-quality studio recordings are not required.

In an expanded characteristic-frequency synthesizer, an emotional expression in the voice can also be added according to the invention.

The voice characteristic can be changed using prefabricated parameter masks, in a very simple manner. The method is also suitable for the conversion of free texts to speech, for example, the reading of e-mail.

Other objects, advantages and novel features of the present invention will become apparent from the following detailed description of the invention when considered in conjunction with the accompanying drawings.

### BRIEF DESCRIPTION OF THE DRAWINGS

The single FIGURE of drawing is a schematic diagram of a preferred embodiment of the invention for a differentiated voice output with several systems according to the invention.

### DETAILED DESCRIPTION OF THE DRAWINGS

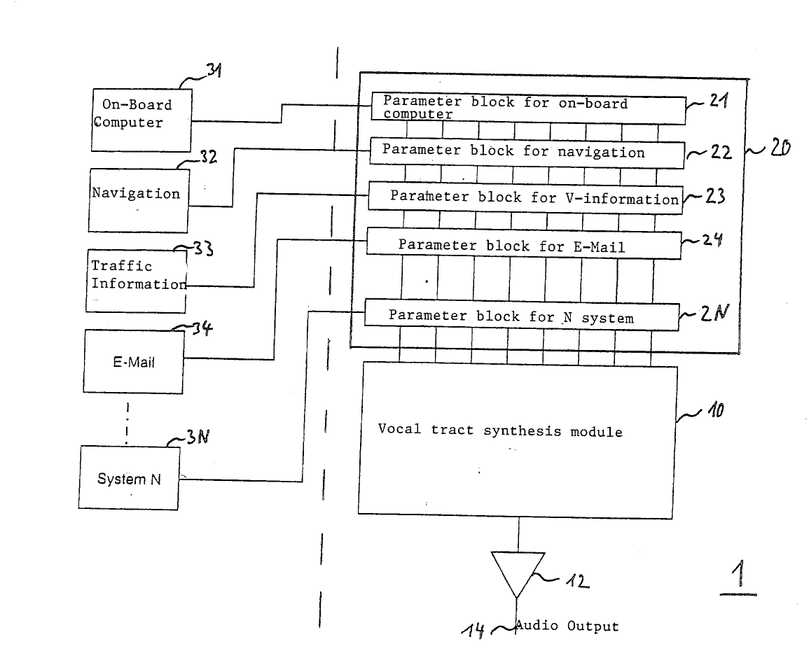

The preferred embodiment of the invention illustrated in FIG. 1 has a voice output unit 1 with a voice synthesis device 10 in the form of a vocal-tract synthesis module, based on a full synthesis of the voice. (For example, a characteristic-frequency synthesizer, such as KLATTALK, can be used.) The voice synthesis device 10 is connected with an amplifier 12 whose output 14 supplies an audio signal which emits voice by way of a loudspeaker (not shown).

N parameter blocks 21, 22 to 2N are assigned to the voice synthesis device 10 and, in the illustrated embodiment, are stored in a memory 20 of the voice output unit 1. Furthermore, N systems 31, 32 to 3N are shown, each of which is connected with the voice output unit 1 by way of a data connection, such as individual lines, a bus system or data channels. Each system can carry out a data output via the data output unit.

In greater detail, the following systems are present: An on-board computer 31 with a pertaining parameter block for the on-board computer 21; a navigation system 32 with a pertaining parameter block for the navigation 22; a traffic information system 33 with a pertaining parameter block for the traffic information 23; an e-mail system, such as a TTS system 34 with a pertaining parameter block for e-mail 24. Additional systems 3N may be provided which have a respective assigned parameter block 2N.

In the illustrated embodiment, it is possible by using a single voice output unit 1 to let the navigation system 32, for example, speak with a soft female voice which is determined by means of the parameter block for the navigation system 22. Furthermore, a parameter block 23 may be provided, for example, for traffic reports by means of which a hard male bass is used for the voice output.

The voice outputs may take place in time sequence corresponding to the input order for the voice output from the systems. Information of a higher priority, such as traffic information in the event of dangerous situations, such as incorrect driving, is first emitted for each voice output. Especially preferably, information of the highest priority, such as from the on-board computer concerning a malfunctioning of the vehicle or a start of slippery road conditions, are emitted immediately, in which case an ongoing voice output can be interrupted. The interrupted voice output can then be concluded or can be repeated.

The invention has the advantage that systems with an acoustic indication provide the driver with information from different systems without diverting the driver's attention from his task, such as occurs during visual displays. Costs can be saved by using a voice synthesis device which can be used by different on-board computers. In comparison to previously used voice-producing methods, for example, in the case of navigation systems, the storage space requirement can be reduced. The invention can be used with particular advantage in motor vehicles.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for differentiated voice output for a plurality of systems, wherein:
the device is connectable with at least first system and second systems;
a first voice characteristic is assigned to a voice output of the first system;
a second voice characteristic is assigned to the voice output of the second system; and
the second voice characteristic audibly differs from the first voice characteristic.

2. The device according to claim 1, further comprising:
a voice synthesis device containing control parameters, including a first class of dynamic parameters and a second class of static parameters;
wherein the dynamic parameters control articulation, corresponding to movement of a voice tract, and the static parameters control voice-characteristic features.

3. The device according to claim 2, wherein the static parameters have a fundamental frequency of the generator and/or fixed characteristic frequencies which correspond to the different geometrical dimension of the voice tract in the case of a child, a woman or a male speaker.

4. The device according to claim 3, wherein:
at least one of generator and characteristic-frequency parameters for the voice output from different systems can be changed; and
audible differences can be caused in the prosody, such as at least one of duration and emphasis of syllable segments, and sentence melody.

5. The device according to claim 2, wherein the voice synthesis device is a characteristic-frequency synthesizer, by which voice-characteristic features can be influenced.

6. The device according to claim 5, wherein:
the characteristic-frequency synthesizer is adapted for separately generating voiced and unvoiced sounds; and
using further parameters, additional resonators or attenuators can be switched on and/or the dynamic parameters for the articulation can be influenced.

7. The device according to claim 2, wherein the dynamic parameters are stored corresponding to the sequence of words, sentences and sentence sequences in each system.

8. The device according to claim 2, wherein:
the static parameters are stored as a parameter block in each system; and
in the event of a required voice output, the parameter block is transmitted to the voice synthesis device.

9. The device according to claim 2, wherein:
the static parameters for the systems are stored as assigned parameter blocks in a memory of the voice output device; and
as a function of a selection signal of a system, an assigned parameter block is used by the voice synthesis device for the voice output.

10. The device according to claim 2, wherein:
the voice synthesis device is connected with an amplifier; and
a voice output takes place takes place by way of an audio output of the amplifier.

11. The apparatus according to claim 1, further comprising a system having a first output for emission of dynamic parameters and a second output for emitting a selection signal for switching a parameter block in the voice output device.

12. The apparatus according to claim 1, further comprising a system having an output for emission of dynamic parameters and static parameters to the voice output device.

13. The apparatus according to claim 12, wherein the static and dynamic parameters comprise a parameter block of said system.

14. The apparatus according to claim 1, further comprising at least first and second systems selected from the group consisting of an on-board computer, a navigation system, a traffic information system, an e-mail system, and an information system.

15. Apparatus for generating differentiated voice signals from a plurality of systems, comprising:
a voice synthesizer;
a memory coupled to said voice synthesizer, said memory having stored therein a plurality of parameter blocks; wherein
each parameter block is associated with a respective one of said systems, and includes voice synthesis information for communication of audible voice signals from the system with which it is associated, via said voice synthesizer.

16. The apparatus according to claim 15, wherein:
each system has assigned thereto a respective voice characteristic; and
said voice characteristics differ from one another.

17. The apparatus according to claim 16, further comprising:
control parameters stored in said voice synthesizer, including a first class of dynamic parameters and a second class of static parameters;
wherein the dynamic parameters control articulation, corresponding to movement of a voice tract, and the static parameters control voice-characteristic features.

18. A method for generating differentiated voice signals from a plurality of systems, said method comprising:
for each system, storing in a memory a parameter block containing voice synthesis information for communication of audible voice signals from said system, via a speech synthesizer; and
communicating information from said systems via said synthesizer, using information contained in said parameter blocks.

19. The apparatus according to claim 18, wherein:
each system has assigned thereto a respective voice characteristic; and
said voice characteristics differ from one another.

20. The method according to claim 19, wherein:
the voice synthesizer contains control parameters, including a first class of dynamic parameters and a second class of static parameters; and
the dynamic parameters control articulation, corresponding to movement of a voice tract, and the static parameters control voice-characteristic features.
